(19) United States
(12) Patent Application Publication
(10) Pub. No.: US 2024/0336012 A1
(43) Pub. Date: Oct. 10, 2024

(54) DEVICES, SYSTEMS, AND METHODS FOR 3D PRINTING OF VASCULATURE

(71) Applicant: BIOMODEX, S.A.S., Paris (FR)

(72) Inventor: Samuel ORRU, Paris (FR)

(21) Appl. No.: 18/294,805

(22) PCT Filed: Aug. 2, 2022
(86) PCT No.: PCT/IB2022/057139

§ 371 Date: Feb. 2, 2024

Related U.S. Application Data
(60) Provisional application No. 63/228,545, filed on Aug. 2, 2021.

(51) Int. Cl. B29C 64/393; B33Y 10/00; B33Y 50/02; G06F 30/10; G06F 113/10; G06F 119/18

(52) U.S. Cl. CPC B29C 64/393; B33Y 50/02; G06F 30/10; B33Y 10/00; G06F 2113/10; G06F 2119/18

(57) ABSTRACT

A method for preparing a 3D printing model. The method includes identifying a centerline path of a vascular feature from a vasculature model. Based on the centerline path and for the centerline path, an arc length, an x-axis length, a y-axis length, and a z-axis length are determined. The centerline path is stretched to reduce the z-axis length.

### CROSS REFERENCE TO RELATED

This application claims benefit and priority to U.S. Provisional Application No. 63/228,545, filed on Aug. 2, 2021, the entirety of which is incorporated herein by reference

### BACKGROUND

Medical procedures may include many risks. Preparation for these procedures helps reduce the risk. 3D models of anatomies have been shown to help reduce these risks by familiarizing a technician with the anatomy.

### BRIEF SUMMARY

In some aspects, the techniques described herein relate to a method for preparing an additive manufacturing model. The method includes identifying a centerline path of a vascular feature from a vasculature model. Based on the centerline path and for the centerline path, an arc length, an x-axis length, a y-axis length, and a z-axis length are determined. The centerline path is stretched to reduce the z-axis length.

In some aspects, the techniques described herein relate to a method for 3D printing a vascular model. The method includes preparing a vasculature model. The vasculature model includes a vascular feature having a centerline and a diameter and a wall thickness. The method includes determining a z-axis length of the vascular feature. The vascular feature is stretched to generate a deformed vasculature model. Stretching the vascular feature is based on the centerline to reduce the z-axis length while maintaining an arc length of the centerline. A printed part of the deformed vasculature model is additively manufactured.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a representation of a vasculature model, according to at least one embodiment of the present disclosure;

FIG. 2 is a representation of a radius and thickness of a vascular feature, according to at least one embodiment of the present disclosure;

FIG. 3 is a representation of centerlines of a vasculature model, according to at least one embodiment of the present disclosure;

FIG. 4A is a representation of a vasculature model, according to at least one embodiment of the present disclosure;

FIG. 4B is a representation of the vasculature model of FIG. 4A deformed;

FIG. 4C is another view of the vasculature model of FIG. 4A;

FIG. 4D is a representation of the vasculature model of FIG. 4A deformed;

FIG. 5A is a representation of a vasculature model, according to at least one embodiment of the present disclosure;

FIG. 5B is a cross-sectional view of the vasculature model of FIG. 5A;

FIG. 5C is a representation of a 3D printed part of the vasculature model of FIG. 5A;

FIG. 5D is a cross-sectional view of the 3D printed part of FIG. 5C;

FIG. 6 is a representation of a vasculature model, according to at least one embodiment of the present disclosure;

FIG. 7A is a representation of a 3D printed part, according to at least one embodiment

of the present disclosure;

FIG. 7B is a representation of the 3D printed part of FIG. 7A deformed;

FIG. 7C is another view of the 3D printed part of FIG. 7A;

FIG. 7D is a representation of the 3D printed part of FIG. 7C deformed;

FIG. 8 is a flowchart of a method for 3D printing a vasculature model, according to at least one embodiment of the present disclosure;

FIG. 9A-1 through FIG. 9C-2 are representations of savings associated with deformed vasculature models, according to at least one embodiment of the present disclosure;

FIG. 10 is a representation of a printed part connected to a frame, according to at least one embodiment of the present disclosure;

FIG. 11A is a representation of a 3D printed part that was not deformed during printing, according to at least one embodiment of the present disclosure;

FIG. 11B is a representation of the 3D printed part of FIG. 11A that was deformed according to methods of the present disclosure during printing;

FIG. 12 is a representation of a computing system, according to at least one embodiment of the present disclosure;

FIG. 13 is an embodiment of a flowchart of a method for preparing an additive manufacturing model; and

FIG. 14 is an embodiment of a flowchart of a method for additively manufacturing a vascular model.

### DETAILED DESCRIPTION

The present disclosure is related to a method to reduce printing cost while preserving topology of additively manufactured parts. Parts many be additively manufactured by 3D printing (as predominantly described without limitation herein), light cured resin printing, stereo lithography, other additive manufacturing processes, or combinations thereof. Topology is important in 3D printing of a medical model such as vasculature. Disclosed herein are improved methods for providing cost reduction of 3D printed anatomy respecting the initial topology. The method of the present disclosure reduces the printing cost for complex shapes such as vasculature (veins, arteries) without affecting its original shape.

The cost of 3D printed parts depends on the total volume, and height is a determiner of printing time. To improve printing costs, parts should be modified to reduce the height. Some 3D printing trays may limit the length of 3D printed parts to 60 cm.

New technologies in 3D printing such as MultiJet 3D printers allow users to create complex models with different stiffnesses within the same part. Little work has been done to identify cost optimization to reduce costs for 3D printed parts. Printing costs optimization will become an important milestone since 3D printing may be expensive compared to other manufacturing processes. US Patent Publication No. US20200064812A1 entitled “Deformation-based additive manufacturing optimization” discloses the use of numerical compression to obtain a flattened part. But such methods do not preserve the topology of the printed model.

### Generating Centerlines (VMTK)

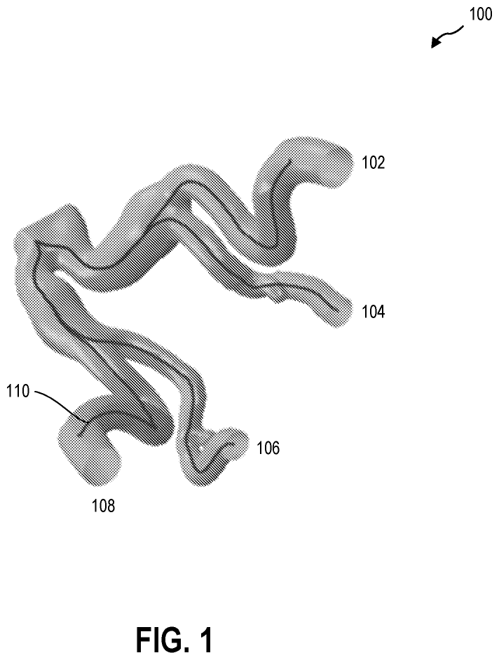

FIG. 1 is a model of an example part to be 3D printed. Virtual centerlines generated using a centerline function of the vascular model toolkit (VMTK) were added to the model. Centerlines are determined as weighted shortest paths traced between two extremal points. VMTK is a Python library available at www.vmtk.org.

A 3D model manager may identify the virtual centerline using the centerline function of the VMTK. For example, the 3D model manager may analyze a vasculature model for vascular features. The vascular features may include one or more arteries or veins. The 3D model manager may identify a lumen through the vascular features. The lumen may be the hole, or the tube through the walls of the vascular feature. Identifying the centerline may include determining the center of the lumen, which may be the point that is equidistance from the walls of the vascular feature, or the point that is.

In some embodiments, the model is a vascular model of a patient's actual vasculature. For example, the model may be based on scans of a specific patient's body, rather than a general model of the vasculature or a specific model of a different patient's vasculature. The VMTK may utilize an input vasculature model of the patient's body to prepare the centerlines. For example, the VMTK may receive the vasculature model 100 and identify one or more vascular paths, such as the RIA (e.g., right iliac artery) 102, the RHA (e.g., right hepatic artery) 104, the LHA (e.g., left hepatic artery) 106, the LIA (e.g., left iliac artery) 108 paths illustrated in FIG. 1, other vascular paths, or combinations thereof. The VMTK may then identify the centerline 110 of one or more of the vascular paths (e.g., the centerline of a single vascular path of a plurlality of vascular paths, the centerline of all of the plurality of vascular paths.

### Displacement of Each Centerline to Obtain a Straight Line

The displacement of each of the centerlines may be calculated. The displacement may be computed as the difference between the total arc length and the z-axis length of the anatomy. The arc length may be the distance along a centerline path of the centerline. The z-axis length may be the distance in the z-axis that the centerline path may travel at its furthest extent in the x-axis direction. The x-axis length may be the distance in the x-axis that the centerline path may travel at its furthest extent in the x-axis direction. The y-axis length may be the distance in the y-axis that the centerline path may travel at its furthest extent in the y-axis direction.

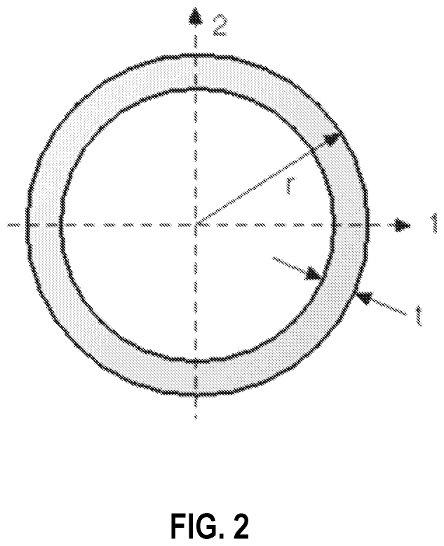

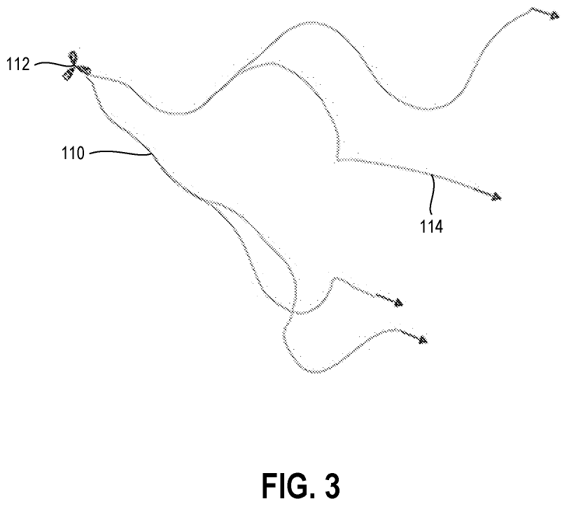

According to one example using Abaqus software from Dassault Systems, the centerline is modeled as a thick-walled pipe with a radius r of 15 mm and a thickness t of 3.8 mm, as may be seen in FIG. 2. According to the present example, the material used is a linear elastic material with a Young's Modulus of 5 MPa and a Poisson's ratio of 0.48. However, it should be understood that the Young's Modulus and the Poisson's ratio may be any value. For example, a material for 3D printing may be selected having the Young's Modulus and the Poisson's ratio that matches or simulates the Young's Modulus and the Poisson's ratio of a patient's vasculature. Each centerline 110 is fixed at its input point 112 and each of the calculated displacement values is applied on the output point 114 of the anatomy, as may be seen in FIG. 3. These values are provided for the sake of example, the invention is not limited to any specific value.

Proximal points (closest to the heart) will be defined as input points and distal points (farthest from the heart) as output points. The terms proximal and distal are used in structures that are considered to have a beginning and an end (such as the upper limb, lower limb and blood vessels) and describe the position of a structure with reference to its origin—proximal means closer to its origin, distal means further away.

### Implementing Centerlines Lengthening (VMTK)

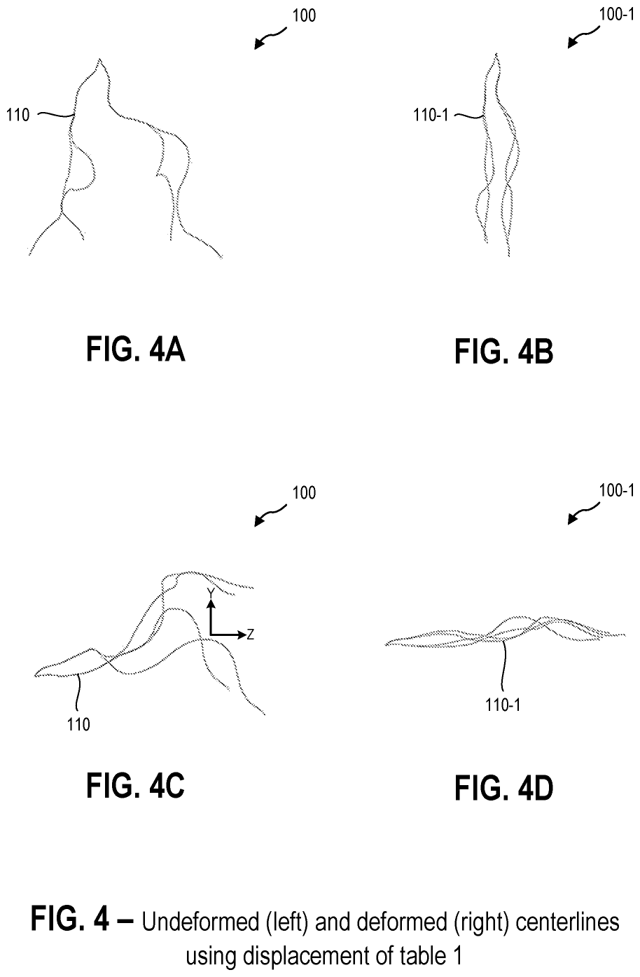

For each centerline in FIG. 4A, the 3D model manager may determine or compute the arc length and its z-axis length. A difference is then computed between the z-axis length and the actual length of a given arc. The 3D model manager may stretch the centerline path. For example, the 3D model manager may extend the centerline path to reduce the z-axis length. This may increase one or both of the x-axis length or the y-axis length. In some embodiments, the deformed vasculature model having a stretched x-axis length and/or stretched y-axis length fit within the 3D printing tray of the 3D printing device. In some examples, stretching the centerline path may maintain the arc length of the centerline path. For example, stretching the centerline path may maintain the total distance of the centerline path by reducing a radius of curvature of one or more of the curves in the vascular features of the vasculature model.

In some embodiments, stretching the centerline path includes maintaining a diameter of the vasculature feature. For example, stretching the centerline path may not reduce or change the diameter of the vascular feature. In some embodiments, stretching the centerline path includes maintaining a shape of the vascular feature. For example, an interior of the vascular feature may have a circular cross-sectional shape, and stretching the centerline path may include maintaining the circular cross-sectional shape of the interior of the vascular feature.

Table 1 identifies displacements needed to obtain a “straight” line for each branch of the 3D vasculature model illustrated in FIG. 1.

TABLE 1
Displacement needed on each branched

| Branches | Displacement (Uz in mm) | z-axis length | Actual length |
|---|---|---|---|
| RHA | 72.07 | 143.56 | 115.63 |
| LIA | 85.50 | 145.34 | 130.84 |
| RIA | 68.33 | 143.68 | 112.01 |
| LHA | 72.61 | 143.95 | 187.63 |

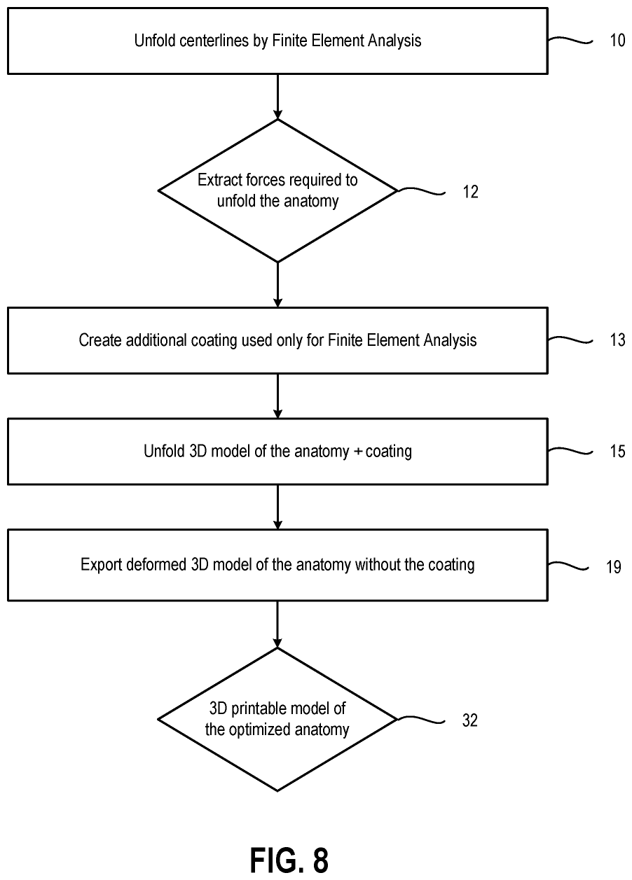

FIGS. 4A-4D illustrate examples of the effect of a longitudinal displacement. FIG. 4A and FIG. 4C illustrates an embodiment of the undeformed vasculature model 100 having an undeformed centerline 110, and FIG. 4B and FIG. 4D illustrate an embodiment of the deformed vasculature model 100-1 with a deformed centerline 110-1. The centerlines in FIG. 4B and FIG. 4D are grouped in a reduced volume in term of height (z-axis) and width (x-axis) (e.g., act 10 in FIG. 8).

### Extracting Forces Required to Stretch Each Centerline (ABAQUS)

A simulation may then be run to obtain the reaction force. Since the deformation is driven by displacement, the equivalent reaction force needed to stretch each centerline on each output maybe calculated (e.g., by Abaqus). Reaction forces are then used to deform the modeled anatomy in one or more embodiments. For each centerline, example resulting forces applied at the output points are displayed in Table 2 (e.g., act 12 in FIG. 8). In at least one embodiment, this act (e.g., act 12 in FIG. 8) is used to improve the convergence of the finite element analysis and is not mandatory. The modeled anatomy could be deformed using displacement and/or reaction force.

TABLE 2
Resulting force at each output node of the centerlines

| Branch | F (N) |
|---|---|
| RHA | −111.8 |
| LIA | −106.8 |
| RIA | −89.42 |
| LHA | −116.1 |

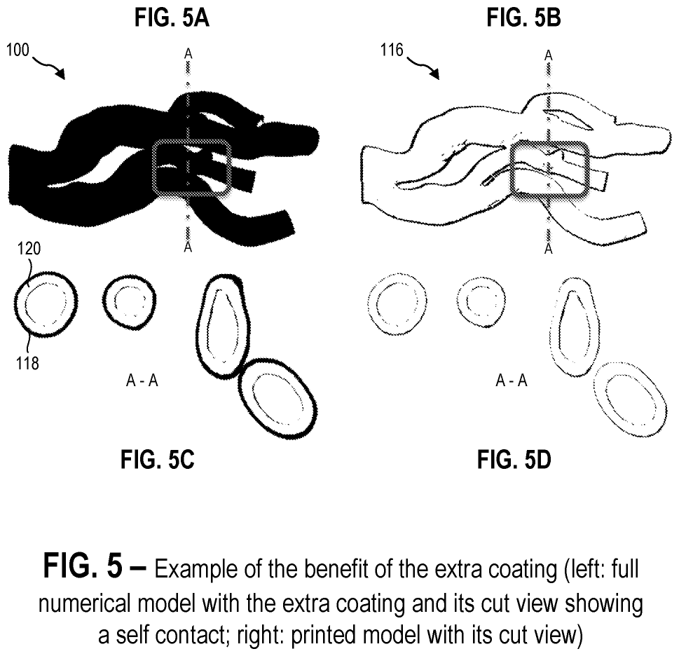

In the deformed state, contact between two branches of the digital 3D model of the anatomy may result in merged branches in the 3D printed part. To avoid merged branches in the 3D printed part, a thin coating 118 (<0.5 mm of thickness) may be applied to the vascular feature 120 of the vasculature model. In one or more embodiments, in the numerical deformation simulation, this may help to prevent the two models from contacting. Prior to printing the 3D model, the coating may be removed from the digital model. This may provide a buffer to the printed 3D model to prevent the two vascular structures from contacting (e.g., act 13 in FIG. 8). The coating is the darkest part in the illustration of the digital 3D vasculature model 100 in FIG. 5A and FIG. 5B. FIG. 5C illustrates an embodiment of the 3D printed part 116 corresponding to the model of FIG. 5A. FIG. 5B and FIG. 5D illustrate respectively an embodiment of the cross sections of the vasculature model 100 and an embodiment of the 3D printed part of FIG. 5A and 5C. This highlights one or more embodiments where the contact in FIG. 5B may be avoided in FIG. 5D.

### Deformation of the Full Modeled Anatomy (ABAQUS)

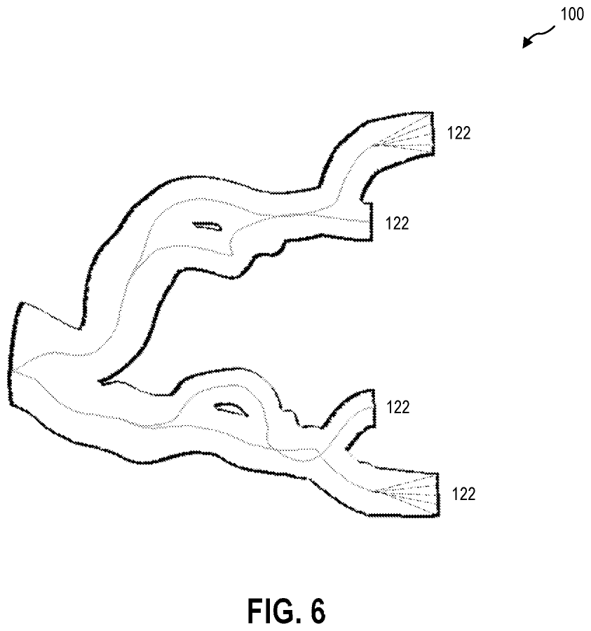

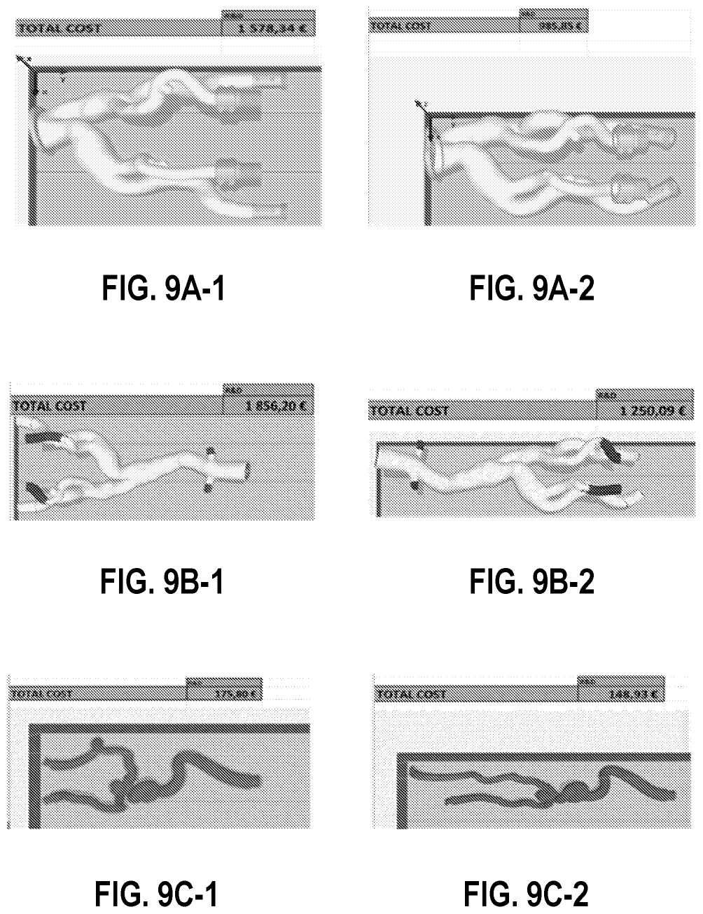

Using the reaction force at each output point of the centerlines, the modeled anatomy may then deform using the lengthening of the centerlines. As may be seen in FIG. 6, each output section of the vasculature model 100 may be constrained using Multi-Point constraints 122 to its corresponding output point of the centerlines (e.g., act 15 in FIG. 9).

The biomechanical properties of the anatomy being modeled may be calculated (e.g., using an optimization algorithm) based on the material used for the 3D printed anatomy. As an example, a target model for the optimization of an abdominal aorta could be as shown below:

Isotropic, hyperelastic, Mooney-Rivlin

$$W = {\sum }_{i = 0 , j = 0}^{n} {C}_{ij} \cdot {( {I}_{1} - 3 )}^{i} \cdot {( {I}_{2} - 3 )}^{j} with {c}_{10} = 17.4 N / {cm}^{2} and {c}_{20} = 188.1 N / {cm}^{2}$$

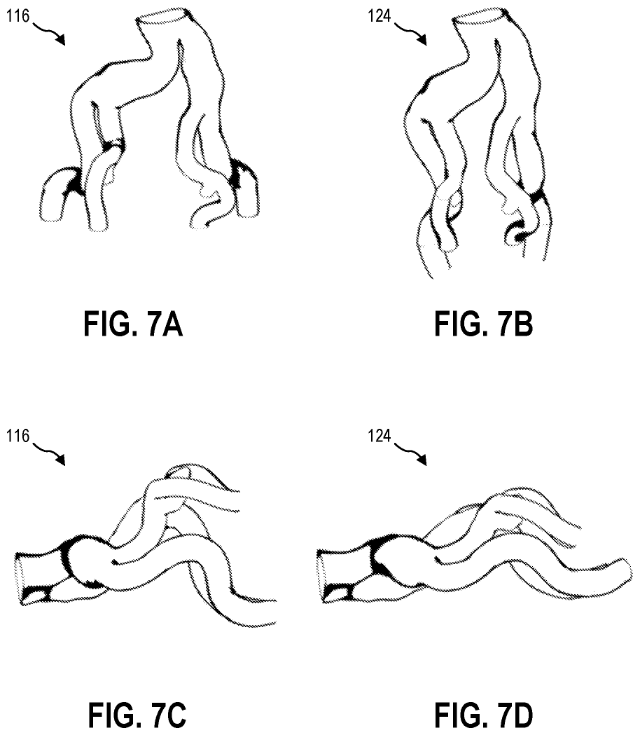

FIGS. 7A-7D illustrate embodiments of the deformed anatomy using the present disclosure. FIG. 7A illustrates a posterior view of an embodiment of the 3D printed part 116 and FIG. 7C illustrates a lateral view of an embodiment of the 3D printed part 116. FIG. 7A and FIG. 7B illustrate embodiments of the undeformed anatomy, while FIG. 7B and FIG. 7D illustrates an embodiment of a deformed printed part 124 at the same points of view.

### Exporting the Deformed Shape of the Anatomy. (ABAQUS)

Once the simulation is done, the deformed shape of the anatomy may be imported into a new model. The aforementioned coating elements may be removed from the full model before exporting parts of the model as STL files (Stereolithography) (e.g., act 19 in FIG. 8). For each desired material, one STL file may be generated. As an example, if a 3D printer is using Polyjet materials, up to 10 STL files (Agilus30Clear, VeroMagenta and 8 digital materials corresponding to a mix between Agilus and VeroMagenta) may be exported. An embodiment of the full workflow is illustrated in the method of FIG. 8.

### Before Printing, the Optimized Model Will be Checked

Thickness verification to avoid very thin layers for 3D printing (it is assumed that vascular wall thickness should be higher than 0.8 mm) may be performed. For example, CATIA V6 may be used using a colored map of thickness. However, any mesh manipulation and/or 3D printing software could be used at this end.

FIG. 8 illustrates a flowchart of a method for preparing a 3D printing model, according to at least one embodiment of the present disclosure. The method may include identifying a centerline path for a vascular feature from a vasculature model. The centerline or the centerline path may be unfolded or stretched using a finite element analysis at 10. In at least one embodiment described herein, this may reduce the z-axis length, thereby reducing the cost and/or time to prepare the 3D printed model.

When the centerline path and/or centerline is unfolded, the 3D printing manager may extract and/or determine forces used to unfold the vascular feature of the vasculature model at 12. The 3D printing manager may create a coating around at leaset one outer surface of the vascular feature of the vasculature model at 13. This coating may be used during the finite element analysis and/or may be removed prior to printing.

The 3D printing manager may stretch and/or unfold the entire anatomy of the vascular model at 15. While unfolding or stretching the vascular feature of the vasculature model, the 3D printing manager may prevent the outer surfaces of the vascular features from contacting each other. For example, the coating may help to prevent the outer surfaces from contacting each other. The deformed 3D model may be exported without the coating at 19 and the model may be printed at 32. In this manner, the cost and/or printing time to print the 3D model may be reduced.

### Optimization Efficiency

Bounding box comparison using VTK (The Visualization Toolkit): a bounding box for each model (clean and optimized) will be generated. Then, a comparison in every cartesian direction will be done. This step allows to compute a first approximation of the optimization done.

The bounding boxes of the clean and the optimized model have been compared to compute the reduction/increase in each direction (in the printer tray reference) in term of volume. The computation is done using the following formula for each direction:

$$t = \frac{{V}_{A} - {V}_{D}}{\vert {V}_{D} \vert}$$

where V_{A} is the optimized value and V_{D} is the initial value.

In this example, the optimization led to:
Change x-axis: −35.2%
Change y-axis: +19.5%
Change z-axis: +27.4%

It means that as shown in FIG. 9A, the height (z axis) and the width (x axis) dimension of the model are reduced inducing an elongation of the y axis)

### GrabCad Estimation

Then, in term of pure costs of 3D printing, the optimization led to a reduction up to 40% (FIGS. 9A-9C). For the sake of comparison, the method has been applied to two other models:
FIG. 9A-1 to FIG. 9A-2 38% of cost reduction (example of the distal half of an abdominal aorta).
FIG. 9B-1 to FIG. 9B-2 32% of cost reduction (example of a full abdominal aorta).
FIG. 9C-1 to FIG. 9C-2 15% of cost reduction (example of an intracranial artery).

### Manufacturing

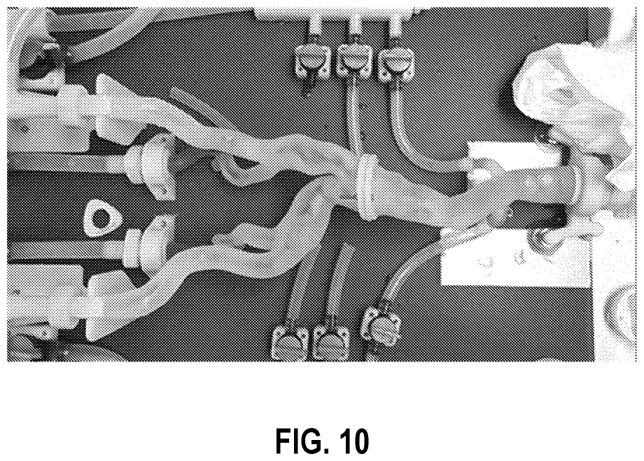

Once printed, the 3D anatomy is mounted on a test fixture such as a frame, as may be seen in FIG. 10 to test the printed anatomy under fluid circulation. When the printed 3D anatomy is mounted on the frame, the printed 3D anatomy may be reformed into the un-deformed shape. Put another way, when the printed 3D anatomy is mounted on the frame, the centerline may be reformed or refolded into the un-deformed shape that resembles the original vasculature model. The frame is a 3D printed standard part which is not patient-specific which creates a fluid-tight coupling with the inlet and the outlet of a patient-specific 3D printed artery. The frame allows the patient-specific 3D printed artery assume the shape of the patient-specific anatomy. Step 32 in FIG. 8.

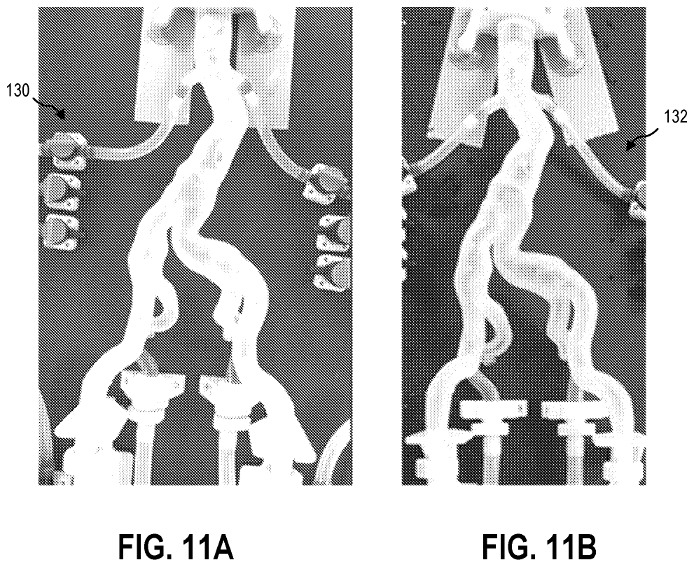

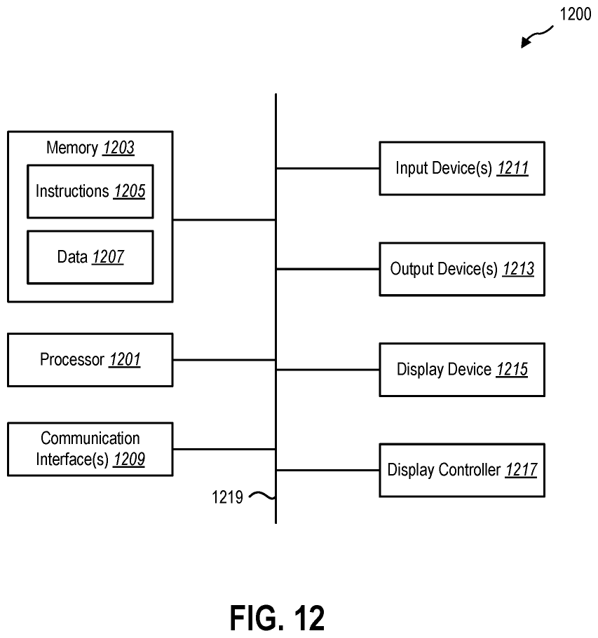

FIG. 10 depicts the two-parts optimized patient-specific 3D artery mounted on the frame while FIGS. 11A-11B are a comparison of non-optimized printed model 130 (FIG. 11A) and optimized printed model 132 (FIG. 11B). The comparison done in FIGS. 11A-12B shows that the 3D printed anatomy returns to the original position of the patient anatomy once constrained by the frame.

FIG. 12 illustrates certain components that may be included within a computing system 1219. One or more computer systems 1219 may be used to implement the various devices, components, and systems described herein.

The computing system 1219 includes a processor 1201. The processor 1201 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 1201 may be referred to as a central processing unit (CPU). Although just a single processor 1201 is shown in the computing system 1219 of FIG. 12, in an alternative configuration, a combination of processors (e.g., an ARM and DSP) could be used.

The computing system 1219 also includes memory 1203 in electronic communication with the processor 1201. The memory 1203 may be any electronic component capable of storing electronic information. For example, the memory 1203 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 1205 and data 1207 may be stored in the memory 1203. The instructions 1205 may be executable by the processor 1201 to implement some or all of the functionality disclosed herein. Executing the instructions 1205 may involve the use of the data 1207 that is stored in the memory 1203. Any of the various examples of modules and components described herein may be implemented, partially or wholly, as instructions 1205 stored in memory 1203 and executed by the processor 1201. Any of the various examples of data described herein may be among the data 1207 that is stored in memory 1203 and used during execution of the instructions 1205 by the processor 1201. The memory 1203 may include a 3D model manager. The model manager may be used during execution of one or more of the instructions 1205 by the processor.

A computing system 1219 may also include one or more communication interfaces 1209 for communicating with other electronic devices. The communication interface(s) 1209 may be based on wired communication technology, wireless communication technology, or both. Some examples of communication interfaces 1209 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computing system 1219 may also include one or more input devices 1211 and one or more output devices 1213. Some examples of input devices 1211 include a keyboard, mouse, microphone, remote control device, button, joystick, trackball, touchpad, and lightpen. Some examples of output devices 1213 include a speaker and a printer. One specific type of output device that is typically included in a computing system 1219 is a display device 1215. Display devices 1215 used with embodiments disclosed herein may utilize any suitable image projection technology, such as liquid crystal display (LCD), light-emitting diode (LED), gas plasma, electroluminescence, or the like. A display controller 1217 may also be provided, for converting data 1207 stored in the memory 1203 into text, graphics, and/or moving images (as appropriate) shown on the display device 1215.

The various components of the computing system 1219 may be coupled together by one or more buses, which may include a power bus, a control signal bus, a status signal bus, a data bus, etc. For the sake of clarity, the various buses are illustrated in FIG. 12 as a bus system 1219.

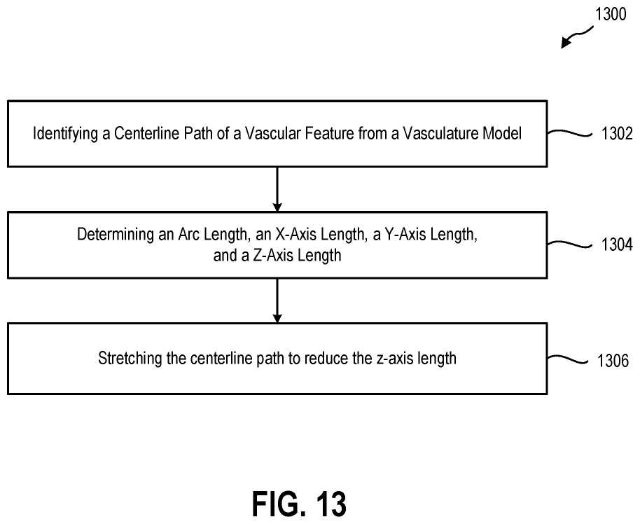

FIG. 13 is an embodiment of a flowchart of a method 1300 for preparing an additive manufacturing model. The method 1300 includes identifying a centerline path (e.g., 110) of a vascular feature from a vasculature model at 1302. An arc length, an x-axis length, a y-axis length, and a z-axis length are determined for the centerline path at 1304. The centerline path may be stretched (e.g., stretched centerline path 110-1) to reduce the z-axis length at 1306.

In some embodiments, stretching the centerline path maintains the arc length of the centerline path. Stretching the centerline path, in some embodiments, increases one or both of the x-axis length or the y-axis length to a stretched x-axis length or a stretched y-axis length. In some embodiments, the stretched x-axis length or the stretched y-axis length fit within a 3D printing tray. Stretching the centerline path, in some embodiments, includes maintaining a diameter of the vascular feature.

In some embodiments, the method 1300 further includes determining a reaction force for the vascular feature based on one or both of Young's Modulus or a Poisson's ratio of the additive manufacturing model. The vascular feature, in some embodiments, is a first vascular feature and the vasculature model further includes a second vascular feature. In some embodiments, stretching the centerline path includes preventing the first vascular feature from contacting the second vascular feature. Preventing the first vascular feature from contacting the second vascular feature, in some embodiments, includes applying a thin coating to an outer surface of the first vascular feature and the second vascular feature. In some embodiments, after stretching the centerline path, the thin coating is removed from the first vascular feature and the second vascular feature.

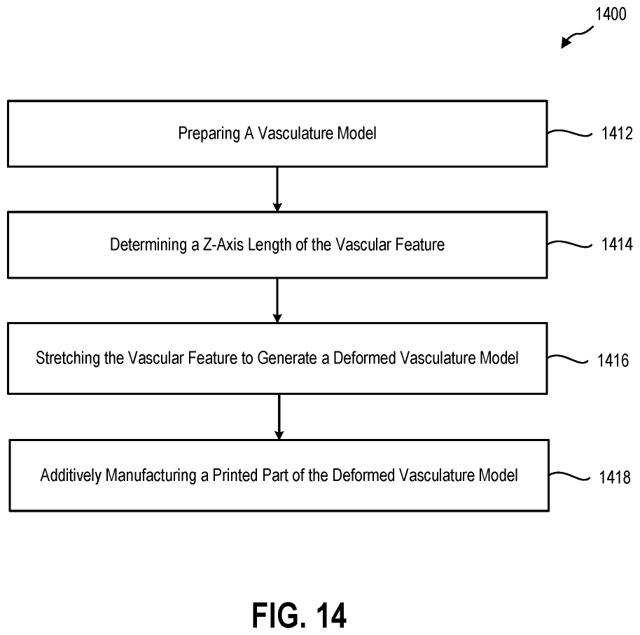

FIG. 14 is an embodiment of a flowchart of a method 1400 for additively manufacturing a vascular model. The method 1400 includes preparing a vasculature model at 1412. In some embodiments, the vasculature model is prepared according to the method 1300 of FIG. 13. In other embodiments, the vasculature model is prepared according to another method. A z-axis length of the vascular feature is determined at 1414. The z-axis length of the vascular feature, in some embodiments, is determined as described by one or more embodiments herein. The vascular feature is stretched to generate a deformed vasculature model at 1416. The deformed vasculature model, in some embodiments, is determined as described by one or more embodiments herein. A printed part of the deformed vasculature model is additively manufactured at 1418. The printed part may be 3D printed, formed from layers of light cured resin, formed by stereolithography, formed by other additive manufacturing methods, or combinations thereof.

In some embodiments, a printed part is mounted to a frame. Mounting the printed part to the frame, in some embodiments, includes reforming the vasculature model. In some embodiments, reforming the vasculature model includes applying a reaction force to the vascular feature to fit the vascular feature in the frame.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. A method for preparing an additive manufacturing model, comprising:
identifying a centerline path of a vascular feature from a vasculature model; based on the centerline path, determining, for the centerline path, an arc length, an x-axis length, a y-axis length, and a z-axis length; and
stretching the centerline path to reduce the z-axis length.

2. The method of claim 1, wherein stretching the centerline path maintains the arc length of the centerline path.

3. The method of claim 1, wherein stretching the centerline path increases one or both of the x-axis length or the y-axis length to a stretched x-axis length or a stretched y-axis length.

4. The method of claim 3, wherein the stretched x-axis length or the stretched y-axis length fit within a 3D printing tray.

5. The method of claim 1, wherein stretching the centerline path includes maintaining a diameter of the vascular feature.

6. The method of claim 1, further comprising determining a reaction force for the vascular feature based on one or both of Young's Modulus or a Poisson's ratio of the additive manufacturing model.

7. The method of claim 1, wherein the vascular feature is a first vascular feature, and the vasculature model further includes a second vascular feature, and wherein stretching the centerline path includes preventing the first vascular feature from contacting the second vascular feature.

8. The method of claim 7, wherein preventing the first vascular feature from contacting the second vascular feature includes applying a thin coating to an outer surface of the first vascular feature and the second vascular feature.

9. The method of claim 8, further comprising, after stretching the centerline path, removing the thin coating from the first vascular feature and the second vascular feature.

10. A method for additively manufacturing a vascular model, comprising:
preparing a vasculature model, the vasculature model including a vascular feature having a centerline and a diameter and a wall thickness;
determining a z-axis length of the vascular feature;
stretching the vascular feature to generate a deformed vasculature model, wherein stretching the vascular feature is based on the centerline to reduce the z-axis length while maintaining an arc length of the centerline; and
additively manufacturing a printed part of the deformed vasculature model.

11. The method of claim 10, further comprising mounting a printed part to a frame.

12. The method of claim 11, wherein mounting the printed part to the frame includes reforming the vasculature model.

13. The method of claim 12, wherein reforming the vasculature model includes applying a reaction force to the vascular feature to fit the vascular feature in the frame.

14. A computing system, comprising:
a processor and memory, the memory including instructions executable by the processor to:
identify a centerline path of a vascular feature from a vasculature model; based on the centerline path, determine, for the centerline path, an arc length, an x-axis length, a y-axis length, and a z-axis length; and
stretch the centerline path to reduce the z-axis length.

15. The computing system of claim 14, wherein stretching the centerline path maintains the arc length of the centerline path.

16. The computing system of claim 14, wherein stretching the centerline path increases one or both of the x-axis length or the y-axis length to a stretched x-axis length or a stretched y-axis length.

17. The computing system of claim 16, wherein the stretched x-axis length or the stretched y-axis length fit within a 3D printing tray.

18. The computing system of claim 14, wherein stretching the centerline path includes maintaining a diameter of the vascular feature.

19. The computing system of claim 14, wherein the instructions further are further executable by the processor to determine a reaction force for the vascular feature based on a Young's modulus and a Poisson's ratio of the vasculature model.

20. The computing system of claim 14, wherein the vascular feature is a first vascular feature, and the vasculature model further includes a second vascular feature, and wherein stretching the centerline path includes preventing the first vascular feature from contacting the second vascular feature.

21. The computing system of claim 20, wherein preventing the first vascular feature from contacting the second vascular feature includes applying a thin coating to an outer surface of the first vascular feature and the second vascular feature.

22. The computing system of claim 21, wherein the instructions further are further executable by the processor to, after stretching the centerline path, remove the thin coating from the first vascular feature and the second vascular feature.
